(19) United States
(12) Patent Application Publication
(10) Pub. No.: US 2008/0230452 A1
(43) Pub. Date: Sep. 25, 2008

(54) Spool valve

(75) Inventors: Hidenori Fujii, Kariya-city (JP); Hiroyuki Nakane, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/073,201

(22) Filed: Mar. 3, 2008

(30) Foreign Application Priority Data
Mar. 20, 2007 (JP) 2007-72943

(51) Int. Cl. B01D 35/157; B01D 21/34

(52) U.S. Cl. 210/130; 210/97

(57) ABSTRACT

A spool valve includes a sleeve, a spool and a filter. The sleeve is configured into a generally tubular form and has an opening, which communicates between inside and outside of the sleeve. The spool is axially slidably supported in the sleeve to change an opening degree of the opening of the sleeve. The filter is installed to the opening of the sleeve to filter fluid, which passes through the opening. The filter is configured into a generally rectangular form such that four outer edge portions of the filter are placed generally in a common imaginary plane. The sleeve includes two guide grooves that receive two opposed sides, respectively, of the filter.

### CROSS REFERENCE TO RELATED APPLICATION

This application is based on and incorporates herein by reference Japanese Patent Application No. 2007-72943 filed on Mar. 20, 2007.

### BACKGROUND OF THE INVENTION

1. Field of the Invention

The present invention relates to a spool valve.

2. Description of Related Art

A spool valve, which serves as a means for switching fluid (e.g., oil), adjusting a flow quantity of fluid, or adjusting a pressure of fluid, is known (see, for example, Japanese Unexamined Patent Publication No. 2002-243057).

FIG. 5 shows an exemplary solenoid hydraulic pressure control valve, in which a spool valve and a solenoid actuator are integrated together. Hereinafter, the same reference numerals will be used to indicate the same components throughout the following description.

The solenoid hydraulic pressure control valve of FIG. 5 is a pilot valve, which controls a supply hydraulic pressure of a pressure control chamber of a hydraulic pressure control valve (hereinafter, referred to as a main valve) that supplies a working hydraulic pressure to a friction engagement device (e.g., a clutch means, a brake means) of an automatic transmission. The solenoid hydraulic pressure control valve includes a spool valve 1 and a solenoid actuator 2. The solenoid actuator 2 drives the spool valve 1.

The spool valve 1 includes a sleeve 3, spool 4 and a return spring 5. The sleeve 3 includes an input port 7, an output port 8 and a drain port 9. The input port 7 receives oil from an oil pump through an oil passage. The output port 8 is communicated with the pressure control chamber of the main valve through an oil passage. The drain port 9 is communicated with an interior of an oil pan. A degree of communication between the input port 7 and the output port 8 and a degree of communication between the output port 8 and the drain port 9 are adjusted by adjusting an axial position of the spool 4, so that an adjusted hydraulic pressure is exerted in the output port 8.

In a case where the degree of communication between the input port 7 and the output port 8 is increased while the degree of communication between the output port 8 and the drain port 9 is decreased, the oil flows from the input port 7 to the output port 8, and the high hydraulic pressure is exerted in the pressure control chamber of the main valve.

In contrast, in a case where the degree of communication between the input port 7 and the output port 8 is decreased while the degree of communication between the output port 8 and the drain port 9 is increased, the oil flows from the output port 8 to the drain port 9, and the hydraulic pressure of the pressure control chamber of the main valve is decreased.

Here, the oil to be guided into the input port 7 is first filtered by an oil filter of an oil strainer before entering into the oil pump, and the filtered clean oil is guided into the input port 7.

Furthermore, the oil, which is returned from the pressure control chamber of the main valve to the output port 8, is also the clean oil, which has passed the spool valve 1.

However, unexpected foreign objects (e.g., cut or ground residues and burrs left at the time of manufacturing, and sand, dust or debris introduced at the time of overhaul maintenance work) may possibly be introduced into the oil passage between the oil strainer and the input port 7.

Similarly, the unexpected foreign objects may possibly be introduced into the oil passage, which communicates between the output port 8 and the pressure control chamber of the main valve.

When such unexpected foreign objects are introduced into the spool valve 1, malfunction of the pilot valve may possibly occur.

Japanese Unexamined Patent Publication No. H05-306783 and Japanese Unexamined Patent Publication No. 2006-258161 disclose a technique, which avoids the malfunction of the pilot valve caused by the foreign objects. According to this technique, two filters J1 are installed to the input port 7 and the output port 8 (each serving as an example of an opening that communicates between inside and outside of the sleeve 3) to limit intrusion of the foreign objects into the interior of the sleeve 3.

The prior art technique of installing the filter J1 to the output port 8 will be described with reference to FIG. 6.

The filter J1 is a pressed product, which is bent into a generally C-shaped form by press working. Two bent portions J2, which are bent radially inward, are formed at opposed longitudinal ends (ends of the C-shaped form) of the filter J1.

The sleeve 3, to which the filter J1 is installed, has a filter receiving recess J3 that receives the filter J1. Two engaging portions J4, which are recessed radially inward and are engaged with the bent portions J2, are formed at opposed ends of the filter receiving recess J3, which are opposed to each other in the longitudinal direction (the circumferential direction) of the filter receiving recess J3.

The filter J1 is installed to the sleeve 3 as follows. That is, the filter J1 is radially inwardly installed into an interior of the filter receiving recess J3 in the radial direction of the sleeve 3, and the bent portions J2 are engaged with the engaging portions J4, respectively, which are provided at the opposed ends of the filter receiving recess J3.

Now, a first disadvantage of the prior art technique will be described.

The filter J1, which is recited in the Japanese Unexamined Patent Publication No. H05-306783 and Japanese Unexamined Patent Publication No. 2006-258161, has the generally C-shaped form, so that the filter J1 cannot be easily installed to the sleeve 3.

Particularly, when the assembling process needs to be automated, an opening direction of the C-shaped form of the filter J1 needs to be first identified. Then, the filter J1 should be moved toward the filter receiving recess J3 while maintain the orientation of the filter J1. Thereafter, the bent portions J2 should be engaged with the engaging portions J4. These steps hinder the automation of the assembling process.

Next, a second disadvantage of the prior art technique will be described.

In the case of providing the filter J1 to the output port 8, the output port 8 is used for conducting both of the inflow of the oil and the outflow of the oil. When the outflow of the oil is conducted through the output port 8, the filter J1 is urged outward by the oil, that is, the filter J1 is urged in the direction away from the sleeve 3 in the radial direction of the sleeve 3.

Since the filter J1 is configured to be installed into the filter receiving recess J3, an installation clearance is provided between the outer edge portions of the filter J1 and the filter receiving recess J3.

Thus, when the outflow of the oil urges the filter J1 in the direction away from the bottom surface of the filter receiving recess J3, a gap may possibly be formed between the filter J1 and the sleeve 3. When such a gap is formed, foreign objects may possibly disadvantageously enter the interior of the sleeve 3 through the gap.

Now, a third disadvantage of the prior art technique will be described.

An effective port cross sectional area of each of the input port 7 and the output port 8 is limited by a fluid filtering portion J5 (aggregation of minute gaps), which actually filters the fluid in the filter J1.

As shown in FIG. 6, the prior art fluid filtering portion J5 and the filter J1 itself are provided in parallel to the axial direction of the sleeve 3, and the surface area of the fluid filtering portion J5 is relatively small. Thus, the fluid filtering portion J5 provides a resistance to the flow of the oil, which passes through the output port 8 (or the input port 7).

As a result, even when a small quantity of foreign objects adheres to the flow filtering portion J5, the flow of oil is substantially reduced at the fluid filtering portion J5. Therefore, the flow of oil is largely hindered at the flow filtering portion J5.

Furthermore, when the temperature of the oil is reduced at the time of starting the engine during the winter season, a viscosity of the oil is increased. Thereby, the flow of oil may be largely hindered at the fluid filtering portion J5, which is the aggregation of the minute gaps.

As discussed above, when the flow of oil is largely hindered by the fluid filtering portion J5 of the filter J1, the output characteristics of the pilot valve (the hydraulic pressure characteristics of the output port 8) may possibly be deteriorated.

Finally, a fourth disadvantage of the prior art technique will be described.

The fluid filtering portion J5, which is provided in the filter J1, is the aggregation of the minute gaps that hinder fine foreign objects contained in the oil to pass therethrough. Therefore, it is difficult to form the fluid filtering portion J5 by press working. In view of this, in the prior art, the fluid filtering portion J5 is produced by forming the minute gaps in the filter J1 of the thin metal plate using an etching technique.

However, the etching technique is a technique for chemically or electrochemically dissolving a surface of the metal, so that the use of the etching technique may result in an increase in the manufacturing costs of the filter J1.

In the above description, although only the pilot valve is used to illustrate the disadvantages of the prior art, the similar disadvantages would occur in the spool valve 1 having the filter J1.

### SUMMARY OF THE INVENTION

The present invention is made in view of the above disadvantages to resolve at least one of the above disadvantages.

According to one aspect of the present invention, there is provided a spool valve, which includes a sleeve, a spool and a filter. The sleeve is configured into a generally tubular form and has an opening, which communicates between inside and outside of the sleeve. The spool is axially slidably supported in the sleeve to change an opening degree of the opening of the sleeve. The filter is installed to the opening of the sleeve to filter fluid, which passes through the opening. The filter is configured into a generally rectangular form such that four outer edge portions of the filter are placed generally in a common imaginary plane. The sleeve includes two guide grooves that receive two opposed sides, respectively, of the filter.

According to another aspect of the present invention, there is provided a spool valve, which includes a sleeve, a spool and a filter. The sleeve is configured into a generally tubular form and has an opening, which communicates between inside and outside of the sleeve. The spool is axially slidably supported in the sleeve to change an opening degree of the opening of the sleeve. The filter is installed to the opening of the sleeve to filter fluid, which passes through the opening. A fluid filtering portion of the filter is bulged in one of a radially outer direction and a radially inner direction of the sleeve with respect to an axis that is parallel to an axial direction of the sleeve.

### BRIEF DESCRIPTION OF THE DRAWINGS

The invention, together with additional objectives, features and advantages thereof, will be best understood from the following description, the appended claims and the accompanying drawings in which:

FIG. 1A is a perspective view showing a sleeve, in which a filter is installed according a first embodiment of the present invention;

FIG. 1B is a cross sectional view seen in an axial direction of the sleeve shown in FIG. 1A;

FIG. 1C is a cross sectional view taken along line IC-IC in FIG. 1B;

FIG. 2 is a cross sectional view of a pilot valve according to the first embodiment;

FIG. 3A is a perspective view showing a sleeve, in which a filter is installed according a second embodiment of the present invention;

FIG. 3B is a cross sectional view seen in an axial direction of the sleeve shown in FIG. 3A;

FIG. 3C is a cross sectional view taken along line IIIC-IIIC in FIG. 3B;

FIGS. 4A to 4D are descriptive diagrams showing manufacturing stages of the filter according to the second embodiment;

FIG. 5 is a cross sectional view of a prior art pilot valve; and

FIG. 6 is a perspective view showing a prior art sleeve, in which a filter is installed.

### DETAILED DESCRIPTION OF THE INVENTION

### First Embodiment

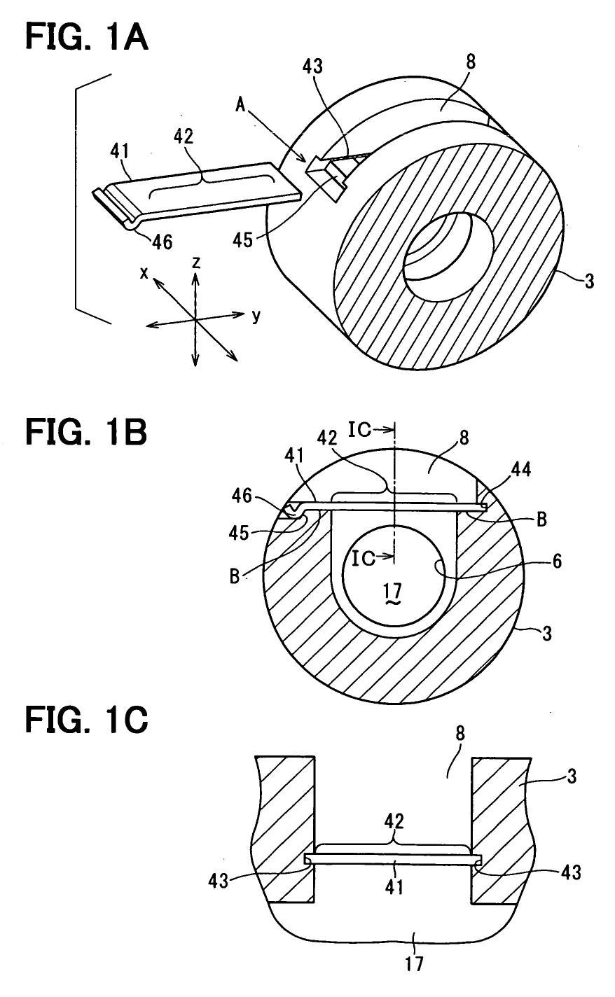

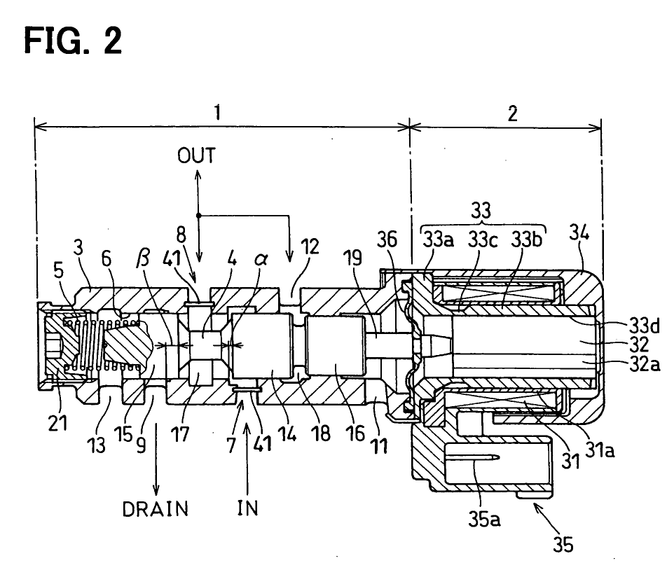

A first embodiment of the present invention will be described with reference to FIGS. 1 and 2. In the first embodiment, the present invention is applied to a pilot valve of a pilot hydraulic pressure control valve.

Now, a main structure of the hydraulic pressure control device will be described.

An automatic transmission includes a plurality of friction engagement devices (e.g., a hydraulic multi-plate clutch, a hydraulic multi-plate brake) and a hydraulic pressure control device. The friction engagement devices are used to change a rotational ratio and a rotational direction of an output of an engine, which generates a vehicle driving force. The hydraulic pressure control device controls engagement and disengagement of each friction engagement device.

Each friction engagement device includes friction elements (e.g., multi-plate elements) and a hydraulic actuator. The hydraulic actuator executes the engagement and disengagement between the friction elements. The hydraulic pressure control device includes a hydraulic pressure control valve, which controls a supply hydraulic pressure of the hydraulic actuator of each friction engagement device.

One such a hydraulic pressure control valve includes a pilot hydraulic pressure control valve, which includes a main valve (not shown) and a pilot valve. The main valve controls the supply hydraulic pressure of the friction engagement devices. The pilot valve drives the main valve.

Now, the pilot valve will be described in detail.

A basic structure of the pilot valve will be described with reference to FIG. 2.

In the following description, a pilot valve of a normally open (N/O) type will be described as an example. However, it should be noted that the present invention is equally applicable to a pilot valve of a normally closed (N/C) type.

The pilot valve is a solenoid hydraulic pressure control valve, which includes a spool valve 1 and a solenoid actuator 2. The spool valve 1 controls a supply hydraulic pressure, which is supplied to a pressure control chamber of the main valve. The solenoid actuator 2 drives the spool valve 1.

Next, the spool valve 1 will be described in detail.

The spool valve 1 includes a sleeve 3, spool 4 and a return spring 5.

The sleeve 3 is configured into a generally cylindrical tubular form and is received in a sleeve receiving hole, which is formed in a case of a hydraulic pressure controller (not shown).

The sleeve 3 has a receiving hole 6, an input port 7, an output port 8 and a drain port 9. The receiving hole 6 axially slidably receives the spool 4. The input port 7 receives oil from an oil pump (a hydraulic pressure generating means) through, for example, an oil passage. The output port 8 is communicated with the pressure control chamber of the main valve through, for example, an oil passage. The drain port 9 is communicated with a low pressure side (e.g., an oil pan).

The oil ports, such as the input port 7, the output port 8 and the drain port 9, are formed in a peripheral wall of the sleeve 3. Specifically, a diaphragm chamber breathing drain port 11, a feedback (F/B) port 12, the input port 7, the output port 8, the drain port 9 and a spring chamber breathing drain port 13 are provided in this order from the right side (solenoid actuator 2 side) to the left side (side opposite from the solenoid actuator 2) in the sleeve 3. The F/B port 12 is communicated with the output port 8 and exerts an F/B pressure, which corresponds to the output pressure, against the spool 4.

The spool 4 is axially slidably received in the sleeve 3 and includes an input seal land 14, a drain seal land 15 and an F/B land 16. The input seal land 14 is provided to seal the input port 7, and the drain seal land 15 is provided to seal the drain port 9. The F/B land 16 has an outer diameter smaller than that of the input seal land 14. A distribution chamber 17 is formed between the input seal land 14 and the drain seal land 15. An F/B chamber 18 is formed between the input seal land 14 and the F/B land 16. The F/B land 16 is provided to seal between the F/B chamber 18 and the diaphragm chamber.

The land diameter of the F/B land 16 is made smaller than the land diameter of the input seal land 14. Thus, when a hydraulic pressure (output pressure), which is applied to the F/B chamber 18, is increased, an axial force (a leftward force in FIG. 2), which counteracts against a spring load of the return spring 5, is exerted to the spool 4 due to a differential pressure caused by a land difference between the input seal land 14 and the F/B land 16. In this way, stable displacement (stable movement) of the spool 4 is achieved, and thereby it is possible to limit fluctuations in the output pressure, which would be caused by fluctuations in the input pressure. The spool 4 is held still at a location where the spring load of the return spring 5, a drive force of the solenoid actuator 2 and the axial force caused by the land difference between the input seal land 14 and the F/B land 16 are balanced.

The spool 4 of the present embodiment includes a shaft 19, which extends into an interior of the solenoid actuator 2. A distal end of the shaft 19 abuts against an end surface of a plunger 32, so that the plunger 32 directly drives the spool 4 through the shaft 19. Here, it should be noted that the shaft 19 may be formed separately from the spool 4 or may be joined to the plunger 32 depending on a need.

The return spring 5 is a spiral coil spring, which urges the spool 4 in a valve opening side. The valve opening side is a side where the input side seal length is reduced to increase the output pressure (the right side in FIG. 2). The return spring 5 is received in a compressed state in a spring chamber located at a left side of the sleeve 3 in FIG. 2. One end of the return spring 5 is engaged with a bottom surface of an adjust screw 21, which closes a left end of the receiving hole 6 of the sleeve 3 in FIG. 2, and the other end of the return spring is engaged with an end portion of the spool 4. The spring load of the returns spring 5 can be adjusted by adjusting an amount of thread engagement (an amount of threaded in).

In the spool valve 1, when the spool 4 is axially displaced by the action of the solenoid actuator 2, a ratio between an effective input side seal length (overwrap a in FIG. 2) of the input seal land 14, which seals between the input port 7 and the distribution chamber 17, and an effective drain side seal length (overwrap β in FIG. 2) of the drain seal land 15, which seals between the distribution chamber 17 and the drain port 9, is changed. Thus, the output pressure of the oil exerted at the output port 8 is changed.

Now, the solenoid actuator 2 will be described in detail.

The solenoid actuator 2 has a known structure, and an exemplary structure thereof will be described below. Here, it should be noted that the structure of the solenoid actuator 2 used in the present invention should not be limited to the following exemplary structure.

The solenoid actuator 2 includes a coil 31, the plunger 32, a stator 33, a yoke 34 and a connector 35.

When the coil 31 is energized, the coil 31 generates a magnetic force to create a magnetic flux loop, which passes through the plunger 32 and a magnetic stator arrangement (stator 33, yoke 34).

The plunger 32 is a generally cylindrical body made of magnetic metal (e.g., iron: a ferromagnetic material that forms a magnetic circuit). In the present embodiment, the plunger 32 is directly slidable along an inner peripheral surface of the stator 33. Alternatively, a cup element or sleeve may be placed between the plunger 32 and the stator 33.

Furthermore, the plunger 32 directly contacts the distal end of the shaft 19 and is urged toward the valve opening side (right side in FIG. 2) together with the spool 4 by the spring load of the return spring 5 applied to the spool 4.

A hole 32a, which axially penetrates through the plunger 32, is a breathing hole, which communicates between the chambers located at opposite ends, respectively, of the plunger 32.

The stator 33 is made of a magnetic metal (e.g., iron: the ferromagnetic material that forms the magnetic circuit). The stator 33 includes an attracting stator section 33a and a slide stator section 33b. The attracting stator section 33a axially magnetically attracts the plunger 32. The slide stator section 33b covers an outer peripheral part of the plunger 32 to radially pass the magnetic flux between the plunger 32 and the slide stator section 33b. The attracting stator section 33a and the slide stator section 33b are magnetically insulated from each other through a magnetic insulation groove (a portion where a large magnetic resistance exists) 33c.

An axial hole 33d is formed in the stator 33 to axially slidably support the plunger 32 therein. The axial hole 33d is a through hole, which extends from one end to the other end of the stator 33.

The attracting stator section 33a is clamped between the sleeve 3 and the yoke 34 and is magnetically coupled with an opening of the yoke 34. The attracting stator section 33a attracts the plunger 32 toward a valve closing side (a side, at which the input port 7 is closed to reduce the output pressure and is the left side in FIG. 2 in the embodiment) by the magnetic force generated by the coil 31.

Furthermore, the attracting stator section 33a includes a tubular portion, which intersects with the plunger 32 in the axial direction when the plunger 32 is attracted to the attracting stator section 33a. An outer peripheral surface of the tubular portion of the attracting stator section 33a is tapered to limit a change in the magnetic attractive force with respect to the amount of stroke of the plunger 32.

Alternative to this structure, a portion of the attracting stator section 33a may be constructed to oppose the plunger 32 in the axial direction.

The slide stator section 33b is formed into a generally cylindrical body, which covers generally the entire outer peripheral surface of the plunger 32 and is magnetically coupled with a bottom portion of the yoke 34. The slide stator section 33b is directly slidably engaged with the plunger 32 to axially slidably support the plunger 32 and also to transmit the radial magnetic flux between the plunger 32 and the slide stator section 33b.

The yoke 34 is a generally cup shaped body made of magnetic metal (e.g., iron: the ferromagnetic material that forms the magnetic circuit), which surrounds the coil 31 and conducts the magnetic flux. Furthermore, the yoke 34 is securely connected to the sleeve 3 upon bending claws, which are formed at an opening end of the yoke 34, against the sleeve 3.

A diaphragm 36 is provided at a connection between the spool valve 1 and the solenoid actuator 2 to partition between the interior of the sleeve 3 and the interior of the solenoid actuator 2. The diaphragm 36 is an annular element made of rubber. An outer peripheral part of the diaphragm 36 is clamped between the sleeve 3 and the stator 33. A center part of the diaphragm 36 is fitted into a groove, which is formed in an outer peripheral surface of the shaft 19. With this construction, the diaphragm 36 limits intrusion of the oil or foreign objects from the sleeve 3 into the interior of the solenoid actuator 2.

The connector 35 is a connecting means for electrically connecting with an electronic control unit (not shown), which controls the pilot valve. Terminals 35a, which are connected to two ends, respectively, of the coil 31, are provided in an interior of the connector 35.

The electronic control unit controls the amount of electric power (an electric current value) supplied to the coil 31 of the solenoid actuator 2 by controlling a duty ratio of the supplied current. The axial position of the plunger 32 and the axial position of the spool 4 are linearly changed by the electronic control unit against the spring load of the return spring 5 by controlling the amount of electric power supplied to the coil 31, so that a ratio between the input side seal length (overwrap α) and the drain side seal length (overwrap β) is changed to control the hydraulic pressure, which is exerted at the output port 8. In this way, the hydraulic pressure of the pressure control chamber of the main valve is changed.

Next, characteristics of the first embodiment will be described.

The characteristics of the first embodiment will be described in the order of “background of the first embodiment”, “technique for addressing disadvantages” and “advantages of the first embodiment”.

First, in order to provide the better understanding of the first embodiment, the background of the first embodiment will be described.

When the spool 4 is moved toward the right side in FIG. 2, a degree of communication between the input port 7 and the output port 8 is increased, and thereby a degree of communication between the output port 8 and the drain port 9 is decreased. Thereby, the oil flows from the input port 7 toward the output port 8, so that the supply hydraulic pressure of the pressure control chamber of the main valve is increased.

In contrast, when the spool 4 is moved toward the left side in FIG. 2, the degree of communication between the input port 7 and the output port 8 is decreased, and thereby the degree of communication between the output port 8 and the drain port 9 is increased. Thus, the oil flows from the output port 8 toward the drain port 9, so that the supply hydraulic pressure of the pressure control chamber of the main valve is decreased.

As described above, in the pilot valve, the oil flows from the input port 7 into the interior of the spool valve 1, and also the oil flows from the output port 8 into the interior of the spool valve 1.

Here, the oil to be guided into the input port 7 is first filtered by an oil filter of an oil strainer before entering into the oil pump, and the filtered clean oil is guided into the input port 7.

Furthermore, the oil, which is returned from the pressure control chamber of the main valve to the output port 8, is also the clean oil, which has passed the spool valve 1.

However, unexpected foreign objects (e.g., cut or ground residues and burrs left at the time of manufacturing, and sand or dust introduced at the time of overhaul maintenance work) may possibly be introduced into the oil passage between the oil strainer and the input port 7.

Similarly, unexpected foreign objects (e.g., cut or ground residues and burrs left at the time of manufacturing, and sand or dust introduced at the time of overhaul maintenance work) may possibly be introduced into the oil passage between the output port 8 and the pressure control chamber of the main valve.

When such unexpected foreign objects are introduced into the spool valve 1, malfunction of the pilot valve may possibly occur.

Now, a technique for addressing the disadvantages will be described.

As described above, in the pilot valve of the first embodiment, the oil flows from the input port 7 into the interior of the spool valve 1 and also flows from the output port 8 into the interior of the spool valve 1. The input port 7 and the output port 8 serve as “openings, which guide the oil (example of fluid) from the outside to the inside of the sleeve 3”.

Two filters 41 are provided to the input port 7 and the output port 8, respectively, to filter the fluid, which passes through the input port 7 and the output port 8.

The filters 41, which are provided to the input port 7 and the output port 8, are generally identical with respect to its structure. In the following description, the structure of the output port 8 will be described as an example with reference to FIGS. 1 and 2.

The filter 41 is formed as a generally rectangular planar element by stamping a thin metal plate. In the filter 41, four outer edge portions of the filter 41 and a fluid filtering portion 42 (an aggregation of minute gaps) extend in a common imaginary plane.

The fluid filtering portion 42 of the first embodiment is different from that of the second embodiment. Specifically, in the fluid filtering portion 42 of the first embodiment, the aggregation of minute gaps is formed by an etching technique applied on the filter 41 made from the thin metal plate.

In the sleeve 3, two guide grooves 43 are formed at an interior (specifically, at an opening end of the distribution chamber 17) of the output port 8 to receive the filter 41. The guide grooves 43 are parallel to each other and receive two opposed long sides, respectively, of the filter 41 from the opening end of the output port 8 (a portion, which is indicated by an arrow A in FIG. 1A and serves as an installation opening for installing the filter 41). When the filter 41 is installed along the guide grooves 43, the filter 41 is placed to cover the entire opening of the distribution chamber 17 in the interior of the outlet port 8. Therefore, the entire oil, which passes through the output port 8, passes the fluid filtering portion 42.

Specifically, the guide grooves 43 determine the installation position and the installation direction of the filter 41, so that the filter 41 is installed in parallel with a two dimensional plane, which extends in both the axial direction of the sleeve 3 (a direction of an x-axis in FIG. 1A) and a direction (a direction of a y-axis in FIG. 1A) perpendicular to the axial direction of the sleeve 3.

The guide grooves 43 are both parallel to the direction of the y-axis, and bottom surfaces of the guide grooves 43 are opposed to each other.

At one ends of the guide grooves 43 (a leading distal end side of the filter 41), a distal end closing groove 44 is formed. One short side of the filter 41, which is located at the leading end of the filter 41 in the installation direction of the filter 41, is received in the distal end closing groove 44. Thereby, the two parallel grooves 43 and the distal end closing groove 44 form a shape of Π (Cyrillic letter Pe).

Here, a step 45 is formed at an installation opening of the guide grooves 43, through which the filter 41 is installed into the guide grooves 43. The step 45 extends along a trailing end (the other short side) of the filter 41, which is located on the trailing side of the filter 41 in the installation direction of the filter 41.

A bent side 46 is formed in the short side of the filter 41, which is at the trailing end of the filter 41. The bent side 46 is engaged with the step 45 at the end of the installation of the filter 41 into the guides 43. The bent side 46 is formed by bending it at the time of forming the filter 41 by the stamping. A height of the bent side 46 (a dimension of the bent side 46 in a direction of a z-axis, which is perpendicular to both of the x-axis and the y-axis in FIG. 1A) is set to be larger than a dimension of an installation clearance in the direction of the z-axis obtained by subtracting a plate thickness of the filter 41 from the dimension of each guide groove 43 in the direction of the z-axis. That is, the height of the bent side 46 is set to limit intrusion of the foreign objects into the interior of the sleeve 3 through the installation opening of the filter 41 upon overlapping between the step 45 and the bent side 46 even when the filter 41 is displaced in the direction of the z-axis, which is the direction of the height of the filter 41, due to the flow of the oil through the filter 41.

Here, the bent side 46 of the filter 41 may be configured such that the bent side 46 is urged against the sleeve 3 and is thereby resiliently deformed to limit unintentional removal of the filter 41 from the bent side 46 upon installation of the filter 41 to the sleeve 3. Also, the bent side 46 of the filter 41 may be configured such that the bent side 46 is fitted into an engaging groove, which is formed in the sleeve 3, to limit the unintentional removal of the filter 41 from the bent side 46 upon installation of the filter 41.

Next, the installation of the filter 41 will be described.

The leading end of the filter 41 (the short side of the filter 41 opposite from the other short side of the filter 41 where the bent side 46 is provided) is installed into ends of the grooves 43, which are provided at the opening end of the output port 8 (the installation opening of the filter 41) and is pushed further along the guide grooves 43. When the leading end of the filter 41 is engaged with the bottom surface of the distal end closing groove 44, the bent side 46 is engaged with the step 45. Thereby, the installation of the filter 41 is completed.

A length of the filter 41 (a longitudinal dimension of the filter 41 measured in the direction of the y-axis) is set such that the trailing end of the filter 41 generally coincides with an outer diameter circle of the sleeve 3 in the installed state of the filter 41 into the guide grooves 43. Thus, when the spool valve 1 is installed into the interior of the sleeve receiving hole of the case of the hydraulic pressure controller, the trailing end of the filter 41 is engaged with the inner peripheral surface of the sleeve receiving hole. Thereby, it is possible to reliably limit the unintentional removal of the filter 41 from the sleeve 3.

The other one of the two filters 41 is installed into the input port 7 in a manner similar to that of the output port 8 described above.

Now, a first advantage of the first embodiment will be described.

In the spool valve 1 of the first embodiment used in the pilot valve, the filter 41 is installed by inserting the filter 41 along the linear guide grooves 43. Thus, the installability of the filter 41 to the sleeve 3 is improved in comparison to that of the prior art.

Furthermore, the filter 41, which has the generally rectangular plate form, is linearly moved to install the filter 41 along the guide grooves 43. In this way, it is possible to implement automatic installation of the filter 41.

Next, a second advantage of the first embodiment will be described.

When the oil flows from the outside of the output port 8 into the inside of the output port 8 (i.e., when the hydraulic pressure of the pressure control chamber of the main valve is reduced), the filter 41 is urged against the radially inner side of the respective guide grooves 43 due to the flow resistance of the oil, which flows from the outside of the output port 8 toward the inside of the output port 8. Thereby, the outer edge portions of the filter 41 are tightly engaged with the radially inner side of the respective guide grooves 43.

Specifically, the two long sides of the filter 41 are engaged with the radially inner side of the guide grooves 43, and the two short sides of the filter 41 are engaged with the opening end surfaces B of the distribution chamber 17. Thus, it is possible to limit formation of a gap between the filter 41 and the sleeve 3.

When the oil flows from the inside of the output port 8 to the outside of the output port 8 (i.e., when the hydraulic pressure of the pressure control chamber of the main valve is increased), the filter 41 is urged against the radially outer side of the respective guide grooves 43 due to the flow resistance of the oil, which flows from the inside of the output port 8 toward the outside of the output port 8. Thereby, the outer edge portions of the filter 41 are tightly engaged with the radially outer side of the respective guide grooves 43.

Specifically, the long sides of the filter 41 are engaged with the radially outer side surfaces of the guide grooves 43. Furthermore, the one short side of the filter 41 (the leading end of the filter 41) is engaged with the radially outer side surface of the distal end closing groove 44. Also, the bent side 46, which is provided at the other short side of the filter 41 (the trailing end of the filter 41), is engaged with the step 45. Thus, it is possible to limit formation of a gap between the filter 41 and the sleeve 3.

As described above, the outer edge portions of the filter 41 are tightly engaged with the sleeve 3 due to the action of the oil flow regardless of the flow direction of the oil, so that the gap is not formed between the filter 41 and the sleeve 3, and thereby it is possible to limit intrusion of the foreign objects through the installation clearance of the filter 41. In this way, it is possible to provide the reliable pilot valve.

### Second Embodiment

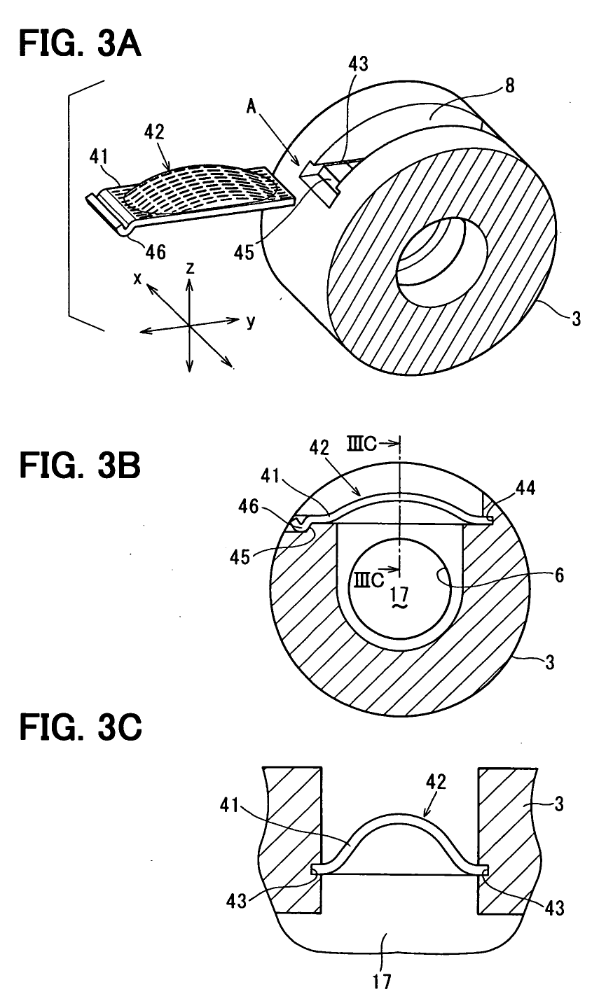

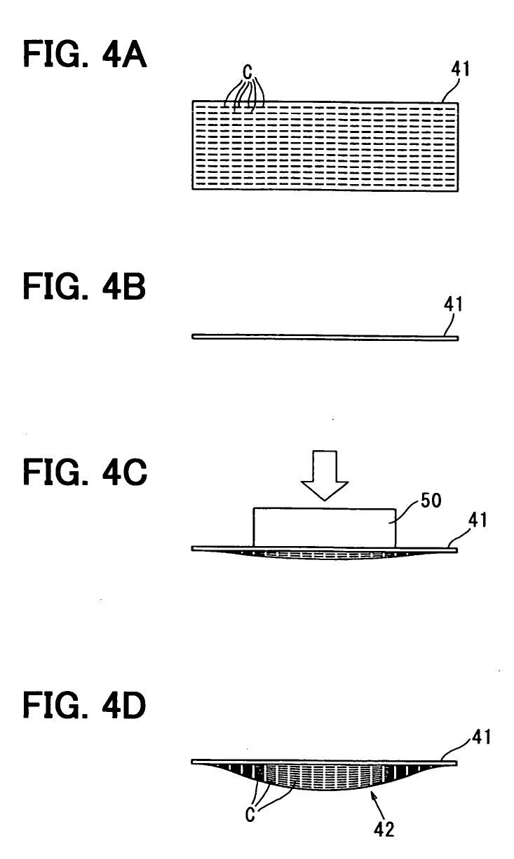

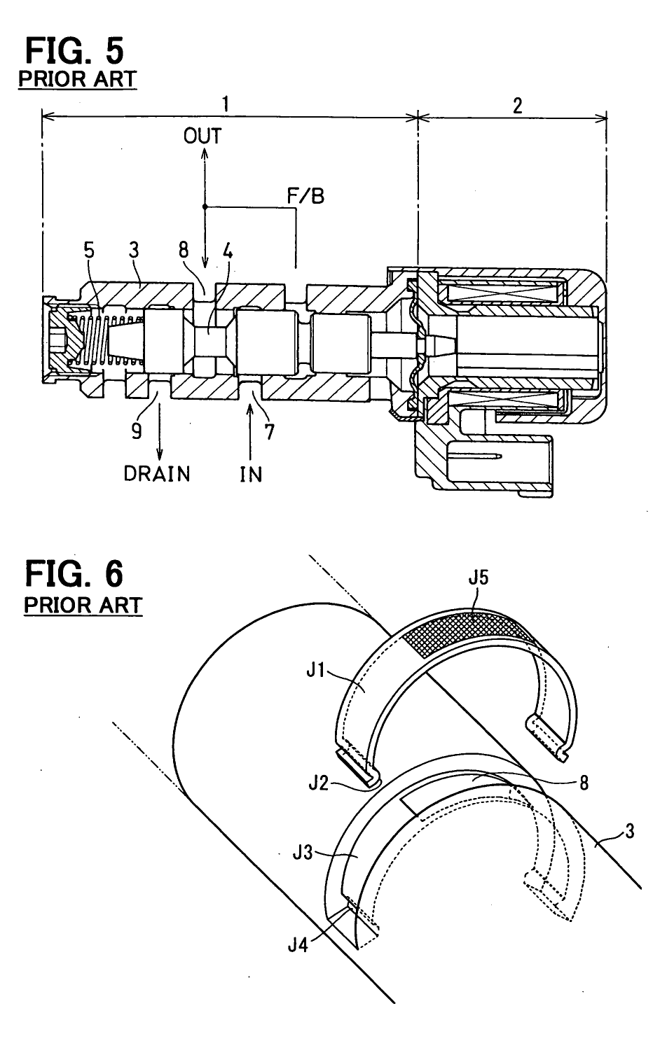

A second embodiment of the present invention will be described with reference to FIGS. 3 and 4. In the second embodiment, a first technical characteristic and a second technical characteristic will be separately described.

Now, the first technical characteristic of the second embodiment will be described.

In the first embodiment, the entire filter 41 is formed into the planar form.

In contrast, according to the second embodiment, the outer edge portions (the four sides) of the filter 41 are configured to define the generally rectangular form, so that the filter 41 is inserted into the guide grooves 43 in a manner similar to that of the first embodiment, and thereby the filter 41 is installed to the sleeve 3. However, in the second embodiment, the fluid filtering portion 42 of the filter 41 is bulged outward with respect to the x-axis (the axis that is parallel to the axial direction of the sleeve 3) in the radial direction of the sleeve 3.

Specifically, the fluid filtering portion 42 of this embodiment is bulged outward in the direction of the z-axis (the radially outward direction of the sleeve 3) and is thereby configured into a shape that resembles a tea strainer, as shown in FIGS. 3A to 3C. The fluid filtering portion 42 is formed to have a configuration similar to a surface configuration of, for example, a portion of an oval sphere.

The fluid filtering portion 42, which has the tea strainer shape, is bulged through press-working, as will be discussed below with respect to “Second Technical Characteristic”.

When the fluid filtering portion 42 is formed into the tea strainer shape, which is bulged radially outward of the sleeve 3, the surface area of the fluid filtering portion 42 can be increased to a relatively large size.

When the surface area of the fluid filtering portion 42 is increased, the flow resistance of the oil in the fluid filtering portion 42 can be reduced, and thereby switching response of the main valve can be increased.

Furthermore, even when a small quantity of foreign objects adheres to the fluid filtering portion 42, the flow resistance of the oil can be reduced in comparison to the prior art due to the increased surface area of the fluid filtering portion 42. Furthermore, even in the case where the temperature of the oil is reduced, for example, at the time of starting the engine under the low temperature during the winter season, the flow resistance of the oil can be reduced in comparison to the prior art. Thereby, the disadvantageous inhibition of the flow of the oil at the fluid filtering portion 42 of the filter 41 can be advantageously limited. As a result, it is possible to limit the deterioration in the output characteristics of the spool valve 1, i.e., the output characteristics of the pilot valve, and thereby it is possible to provide the reliable pilot valve.

Now, the second technical characteristic of the second embodiment will be described.

In the first embodiment, the fluid filtering portion 42 is formed by the etching technique.

In contrast, according to the second embodiment, the fluid filtering portion 42 is formed to have a plurality of slits C. When the fluid filtering portion 42 (the portion having the plurality of slits C) is bulged into the tea strainer shape discussed in the first technical characteristic, the respective slits C are opened to form minutes gaps.

Next, an exemplary manufacturing method of the fluid filtering portion 42, in which the slits C are bulged, will be described with reference to FIGS. 4A to 4D.

First, as shown in FIGS. 4A and 4B, which indicate a plan view and a lateral view, respectively, of the filter 41, the slits C are formed in generally an entire area of the filter 41 configured into the planar shape. The slits C may be formed by the press working or may be formed by laser light.

Next, as shown in FIG. 4C, a region of the filter 41, which is other than the outer edge portions of the filter, is bulged by the press working using a bulging die 50.

Upon the press working, as shown in FIG. 4D, the fluid filtering portion 42 is bulged, so that the respective slits C are opened to form the minute gaps, which limit the flow of foreign objects therethrough.

As described above, by bulging the fluid filtering portion 42, the slits C are opened to form the minute gaps. Therefore, the minute gaps can be easily formed to limit the costs of the filter 41. In this way, it is possible to limit the costs of the pilot valve, which includes the spool valve 1 having the filter 41.

Now, modifications of the above embodiments will be described.

In the second embodiment, the fluid filtering portion 42 is radially outwardly bulged. Alternatively, the fluid filtering portion 42 may be radially inwardly bulged as long as it does not cause any trouble (e.g., as long as the fluid filtering portion 42 does not contact the spool 4).

Furthermore, in the second embodiment, the fluid filtering portion 42 of the filter 41, which is initially formed into the planar shape, is bulged. Alternatively, the fluid filtering portion of the C-shaped filter (e.g., the filter disclosed in Japanese Unexamined Patent publication No. H05-306783), which is formed by bending the rectangular thin plate into the C-shape, may be inwardly bulged.

Furthermore, in the second embodiment, the fluid filtering portion 42 is bulged to have the arcuate three-dimensional shape having the generally spherical surface. Alternatively, the fluid filtering portion 42 may be bulged to have any other suitable three-dimensional shape, such as a triangular three-dimensional shape, a trapezoidal three-dimensional or a polygonal three-dimensional shape.

In the above embodiments, only one of the short sides of the four sides (four outer edge portions of the rectangular shape) of the filter 41 is bent. Alternatively, the remaining three sides may be bent by a small angle. Then, by utilizing a restoring force of these bent portions, the four sides (four outer edge portions) of the filter 41 may be urged against side surfaces of the guide grooves 43 and the distal end closing groove 44 to eliminate the installation clearance of the filter 41.

In the first and second embodiments, the filters 41 are installed to the input port 7 and the output port 8, respectively. Alternatively, the filter 41 may be installed only one of the input port 7 and the output port 8.

In the first and second embodiments, the filters 41 are installed to the input port 7 and the output port 8, respectively. Alternatively, the filter 41 may be installed to any other port, such as the drain port 11, the F/B port 12 and/or the drain port 13.

In the first and second embodiments, the present invention is implemented in the pilot valve. Alternatively, the present invention may be implemented in the main valve.

In the first and second embodiments, the supply hydraulic pressure of the friction engagement device is controlled through the combination of the pilot valve and the main valve. Alternatively, the present invention may be applied to one, in which the supply hydraulic pressure of the friction engagement device is controlled by a single solenoid hydraulic pressure control valve.

In the first and second embodiments, the present invention is applied to the hydraulic pressure control valve used in the hydraulic pressure control device of the automatic transmission. Alternatively, the present invention may be applied to a fluid control valve of any other device, which is other than the automatic transmission. Specifically, the present invention may be applied to an oil flow control valve (OCV) of a variable valve timing (VVT) mechanism, which varies an advance angle of a camshaft.

In the first and second embodiments, the present invention is applied to the spool valve 1, which has the three-way valve structure. Alternatively, the present invention may be applied to a spool valve, which has a two-way valve (opening/closing valve) or four-way valve structure.

In the first and second embodiments, the solenoid actuator 2 is used as the drive means of the spool valve 1. Alternatively, it is possible to use any other drive means, such as a linear drive using an electric motor, a piezoelectric-actuator using a piezoelectric stack, a fluid pressure actuator using a hydraulic pressure or intake negative pressure.

Additional advantages and modifications will readily occur to those skilled in the art. The invention in its broader terms is therefore not limited to the specific details, representative apparatus, and illustrative examples shown and described.

What is claimed is:

1. A spool valve comprising:
a sleeve that is configured into a generally tubular form and has an opening, which communicates between inside and outside of the sleeve;
a spool that is axially slidably supported in the sleeve to change an opening degree of the opening of the sleeve; and
a filter that is installed to the opening of the sleeve to filter fluid, which passes through the opening, wherein:
the filter is configured into a generally rectangular form such that four outer edge portions of the filter are placed generally in a common imaginary plane; and
the sleeve includes two guide grooves that receive two opposed sides, respectively, of the filter.

2. The spool valve according to claim 1, wherein a fluid filtering portion of the filter is bulged in one of a radially outer direction and a radially inner direction of the sleeve with respect to an axis that is parallel to an axial direction of the sleeve.

3. The spool valve according to claim 2, wherein:
the fluid filtering portion of the filter includes a plurality of slits; and
the fluid filtering portion of the filter is bulged in the one of the radially outer direction and the radially inner direction of the sleeve with respect to the axis that is parallel to the axial direction of the sleeve to open each of the plurality of slits and thereby to form a minute gap.

4. The spool valve according to claim 1, wherein the spool valve is a hydraulic pressure control valve, which switches a hydraulic pressure or which adjusts the hydraulic pressure.

5. The spool valve according to claim 1, wherein the spool is driven by a solenoid actuator, which exerts a drive force to the solenoid by a magnetic force generated upon energization of the solenoid actuator.

6. A spool valve comprising:
a sleeve that is configured into a generally tubular form and has an opening, which communicates between inside and outside of the sleeve;
a spool that is axially slidably supported in the sleeve to change an opening degree of the opening of the sleeve; and
a filter that is installed to the opening of the sleeve to filter fluid, which passes through the opening, wherein a fluid filtering portion of the filter is bulged in one of a radially outer direction and a radially inner direction of the sleeve with respect to an axis that is parallel to an axial direction of the sleeve.
